(19) United States
(12) Patent Application Publication
(10) Pub. No.: US 2006/0045038 A1
(43) Pub. Date: Mar. 2, 2006

(54) Method and apparatus for transmitting and receiving multiple services utilizing a single receiver in a broadband satellite system

(76) Inventors: Stanley Kay, Rockville, MD (US); John Schmid, Gaithersburg, MD (US); Mark Steber, Frederick, MD (US); Adrian Morris, Darnestown, MD (US); William Garner, Gaithersburg, MD (US); Richard Clewer, Ijamsville, MD (US)

Correspondence Address: THE DIRECTV GROUP, INC., RE/R11/A109, P.O. Box 956, El Segundo, CA, 90245-0956, US

(21) Appl. No.: 10/927,844

(22) Filed: Aug. 27, 2004

(51) Int. Cl. H04B 7/185

(52) U.S. Cl. 370/316

(57) ABSTRACT

A satellite-based communications network employing at least one satellite and a plurality of user terminals adapted for use with the communications network. The network includes a transmitter for transmitting data to the plurality of user terminals, where the data includes a plurality of broadcast modes and/or services. The transmitter transmits data in a packetized format in which a predetermined number of data packets are transmitted in a frame, where the frame is defined as a predetermined period of time. Further, the transmitter transmits each of the plurality of broadcast modes utilizing a single carrier frequency. Each of the plurality of user terminals includes a receiver for receiving the transmitted data and for regenerating the data so that the data is made available to a device coupled to the user terminal.

### FIELD OF THE INVENTION

The invention relates to a method and apparatus for transmitting and receiving multiple services concurrently in a satellite system configured to transmit broadband multimedia information between two users or to multiple users via a plurality of delivery options. More particularly, the present invention relates to a method and apparatus which allows for a single receiver to receive multiple types of services from multiple geographic sources concurrently, utilizing a single carrier frequency for the downlink transmission.

### BACKGROUND OF THE INVENTION

Society has an ever increasing appetite for the exchange of information. A number of communication systems exist which attempt to satisfy society's communications needs. A useful communication system should be reliable, inexpensive and available to a wide percentage of the population, even in geographically remote areas. Existing communication systems each have numerous disadvantages. For example, digital subscriber line (xDSL) services have been proposed to accommodate the transport of digitized voice and data on analog telephone lines. However, difficulties have been experienced with insuring that xDSL services consistently deliver the bandwidth that is requested by users. In addition, xDSL provides only access type of services where all communication goes through a central site and is not capable of providing communications between individual users in support of peer-to-peer services.

Other examples of communication systems include wireless networks to provide for the transmission of packetized data over cellular voice networks, personal communication systems (PCS), and point-to-multipoint systems for broad-band wireless network access. These systems are disadvantageous in that they limit users delivery options. For example, cellular voice networks are limited to voice communications and personal communication systems provide access to either very limited information or provide internet access at relatively slow data rates compared to even dial-up connections. Furthermore, cellular and PCS systems are still geographically limited to locations where the cellular infrastructure exists.

Satellite communication systems are advantageous because they can serve an extremely wide geographic region. For example, a single geosynchronous satellite may service the entire North American continent. Very small aperture terminal (VSAT) satellite networks provide business enterprises and other organizations with local area network (LAN) internetworking, batch and interactive transmission service, interactive voice, broadcast data and voice communications, multimedia image transfer service, and other services, between a number of sites equipped with VSATs and a site designated as their headquarters. Some existing VSAT satellite networks, however, are disadvantageous in that they typically use large antennas, require double satellite hops through a central hub for VSAT to VSAT data transfers, and transmit and receive at relatively low data rates. Other satellite systems provide only push internet service to consumers (i.e. access to selected information available via internet) and do not provide full access to all internet information and full connectivity.

Two very important considerations in a two-way satellite communication system will be the system's capacity and the cost of the satellite terminals. The capacity of the system is determined by the frequency band allocated to the system. For Ka band Fixed Satellite Services, a contiguous spectrum of 500 MHz is typically allocated for the downlink as well as the uplink. The capacity of the system is increased by dividing the coverage area into geographically distinct uplink and downlink cells. Multiple modulators and beam shaping are utilized on the satellite to limit the coverage of each beam to a particular cell or group of cells. In this manner, the allocated spectrum may be reused in geographically distinct areas.

In addition, the cost of satellite terminals (ST) should be kept to a minimum. Because many STs will be present within each uplink and downlink cell, each uplink cell is typically assigned to a particular sub-band of the allocated spectrum, and each ST within the uplink cell is typically assigned to a particular time slot. Thus, it is critical to the functioning of the system for the STs to be synchronized in both timing and frequency with the satellite. Traditional satellite systems incorporate a beacon signal on a separate carrier frequency in order to synchronize the ST with the satellite. However, providing a beacon signal on a separate carrier requires an additional modulator on the satellite and additional hardware for demodulating the beacon signal at the ST. This adds unwanted cost and complexity to the system.

Another problem facing known communication systems relates to the ability of the receiver to receive multiple types of services from multiple sources that may be in different geographic locations in a concurrent manner. In current systems, if multiple types of services being transmitted from multiple sources are to be received concurrently by a given ST, it is necessary to provide multiple receivers in the ST. Typically, in such a system, each transmitting source will use a different carrier frequency. Alternatively, the ST may include a tunable receiver, which can be “tuned” to receive one of a number of the multiple carrier signals, but this has the disadvantage of not readily supporting multiple concurrent services In either case, if it is desired to be able to receive multiple services concurrently, the cost of the ST is substantially increased due to the fact that the ST needs to include either multiple receivers or a tunable receiver. It is noted that the utilization of a tunable receiver not only negatively impacts the cost of the ST due to the additional components necessary for making the receiver “tunable”, but also negatively impacts overall data processing due to the generation and transmission of command signals necessary for controlling the tuning of the receiver between the two carrier frequencies.

Accordingly, a need exists for a communication system capable of operating in a multimode environment (i.e., one in which multiple types of services, including peer-to-peer, multicast and broadcast, which are transmitted from multiple potentially geographically separate locations to the ST in a substantially concurrent manner) and for receiving multiple services in a substantially concurrent manner, which comprises an ST that requires the use of only a single receiver, so as to provide cost effective STs for use in the communication system.

### SUMMARY OF THE INVENTION

The present invention solves the aforementioned problems by providing a communication system having an ST comprising a multimode receiver capable of receiving multiple types of services from multiple geographic sources in a substantially concurrent manner utilizing a single receiver. This allows any ST in the communication system to participate in multimedia communication between individual users (i.e. peer-to-peer), to a community of users (i.e. multicast and broadcast) or to any number of central sites (i.e. Hubs) in a concurrent manner. In the preferred embodiment of the present invention, the communication system is a two-way, broadband, multimedia wireless communication system.

As described in further detail below, in the preferred embodiment of the present invention the communication system is capable of a plurality of different downlink transmission modes: Beacon, Point-to-Point and CONUS. The beacon is common to all STs, in the system and is sourced from the satellite. The beacon signal is a unique transmission burst that is sent by the satellite in the beginning of each downlink frame and is received by all STs in the system. The beacon signal contains the reference for the downlink carrier frequency, symbol timing and frame timing. The frame timing in conjunction with system configuration information allows the ST to determine where in the downlink frame to switch between receiving the beacon, point-to-point and CONUS signals. The point to point (PTP) mode allows mesh connectivity between individual satellite terminals (STs) in which the uplink information from a given source ST is multiplexed into a downlink carrier that is transmitted by the satellite to a limited geographic region that contains the destination ST. In addition, there is the capability in which one uplink signal from a given ST is replicated by the satellite and transmitted to multiple geographic regions The continental United States (CONUS) mode allows broadcasting of information to multiple STs within the entire continental United States (CONUS).

Furthermore, the satellite downlink architecture is configured such that the downlink signal is divided into frames, each of which is divided into a plurality of slots. The division of the downlink transmission signal allows for the dynamic allocation of the total system capacity between the PTP mode of operation and the CONUS mode of operation. The capacity split between the PTP mode and CONUS mode is adjusted by changing the percentage of time the downlink is in the PTP mode vs. CONUS mode (i.e., by changing the number of slots of a given frame allocated to PTP mode and CONUS mode). The allocation between modes can be changed on a frame to frame basis.

By transmitting the downlink signal in the foregoing frame format (i.e., packetized data format), it is possible for the receiver contained in the ST to process (i.e., receive) both PTP mode signals and CONUS mode signals in a substantially concurrent manner (i.e., within the same frame). Importantly, a single receiver can receive and process both the PTP signals and the CONUS signals, which are transmitted from the satellite on the same carrier frequency. In other words, a single receiver can receive multiple broadcast modes or services in a substantially concurrent manner.

The satellite architecture is such that the downlink signals are packetized and multiplexed so as to allow a plurality of data signals from a plurality of different sources to be contained with a single frame, thereby allowing the information from multiple uplink STs to be multiplexed and transmitted using a single downlink carrier and the proper downlink transmission mode depending on the geographic coverage requirements (i.e., how many STs need to receive the data and where the STs are located). This allows an ST using one multimode receiver to participate in multiple broadband services using multiple downlink modes and from multiple source STs all in potentially different geographic regions all in a concurrent manner.

In addition, the present invention relates to a satellite-based communications network employing at least one satellite and a plurality of user terminals adapted for use with the communications network. The network includes multiple transmitters for transmitting data to the plurality of user terminals, where the data includes a plurality of broadcast modes and/or services. The transmitter transmits data in a packetized format in which a predetermined number of data packets are transmitted in a frame, where the frame is defined as a predetermined period of time. Further, the transmitter transmits each of the plurality of broadcast modes utilizing a single carrier frequency. Each of the plurality of user terminals includes a single receiver for receiving the transmitted data and for regenerating the data so that the data is made available to a device coupled to the user terminal.

Such a system provides significant advantages in various scenarios. For example, when transmitting a national event such as the “Super Bowl”, the nationally relevant data content would be transmitted by the satellite via the downlink transmission signal to a national audience utilizing the CONUS mode. However, the data content (i.e., PTP mode) which is only applicable or relevant to a particular geographic region or area, such as for example, local area commercials, can be included in the same frame as the CONUS signal. Because both signal modes are included in the same frame of the downlink transmission signal and are transmitted over the same carrier signal, the receiver of the ST can receive and process both PTP mode signals and CONUS mode signals as the signals are being received (i.e., in a substantially concurrent manner). In other words, the receiver can simply switch back and forth between processing PTP mode signals and CONUS mode signals in accordance with the data content of the transmitted frames.

In other words, the multimode receiver changes the specific signal processing including symbol rate for each of the different modes: Beacon, PTP and CONUS on a real time bases within each frame based on the frame timing and system configuration information (i.e. programmable PTP/CONUS ratio).

Importantly, as a result of the present invention, there is no need to provide a separate receiver, or for a tunable receiver capable of tuning to another carrier frequency, when the incoming downlink signals changes between Beacon, PTP mode and CONUS mode. It is noted the signal modes (i.e., Beacon, PTP and CONUS) set forth in the foregoing example are intended only for exemplary purposes, and that the present invention is not intended to be limited to these modes of operation. As will be appreciated by one of skill in the art, the method and system of the present invention can also be utilized with other modes of operation.

The present invention provides important advantages over prior art systems. Most importantly, the system of the present invention provides for the reception of a plurality of different transmission modes and broadband services utilizing a single receiver. As such, the overall cost of the individual STs can be minimized, while simultaneously increasing the flexibility of the system to deliver broadband content to the STs.

In addition, the receiver of the present invention can receive a signal from any other transmitter in the network, and it is not dependent on receiving from a head end or gateway. The source can be another peer to peer transmit/receive device. As such, the single receiver of the present invention allows for any combination of sources and transmission modes. The receiver of the present invention can also be programmed to change the number of transmitters it receives from so as to allow for dynamic switching.

Moreover, the receiver of the present invention can operate at a symbol rate that is many times higher in speed than conventional receivers, which allows for the reception equivalent corresponding to the available spectrum allocated. Thus, at one receive point, there is the capability to receive data equivalent to the total available spectrum. As a result, the present invention can offer higher bandwidth services at one physical geographic point than conventional receivers.

Additional advantages of the present invention will become apparent to those skilled in the art from the following detailed description of exemplary embodiments of the present invention.

The invention itself, together with further objects and advantages, can be better understood by reference to the following detailed description and the accompanying drawings.

### BRIEF DESCRIPTION OF THE DRAWINGS

FIG. 1 illustrates an exemplary satellite communication system configuration of the present invention.

FIG. 2 illustrates uplink and downlink packetized transmissions of a satellite communication system in accordance with an embodiment of the present invention.

FIG. 3 illustrates a uplink frequency reuse pattern in a satellite communication system in accordance with an embodiment of the present invention.

FIG. 4 illustrates downlink beams in a satellite communication system in accordance with an embodiment of the present invention.

FIG. 5 illustrates a plurality of delivery options provided for an exemplary geographic area in accordance with an embodiment of the present invention.

FIG. 6 depicts a satellite terminal constructed in accordance with an embodiment of the present invention.

FIG. 7 is an exemplary functional block diagram of the ST 40, illustrating the components included in a typical ST 40.

FIG. 8 illustrates a block diagram of an exemplary implementation of the modem subsystem.

FIG. 9 illustrates an exemplary TDM frame structure used for downlink transmission in accordance with an embodiment of the present invention.

FIG. 10 shows an example of a beacon slot structure in accordance with an embodiment of the present invention.

FIG. 11 illustrates an example of a TDM slot structure in accordance with an embodiment of the present invention.

FIG. 12 shows an example of an idle burst slot structure in accordance with an embodiment of the present invention.

### DETAILED DESCRIPTION OF THE PREFERRED EMBODIMENTS

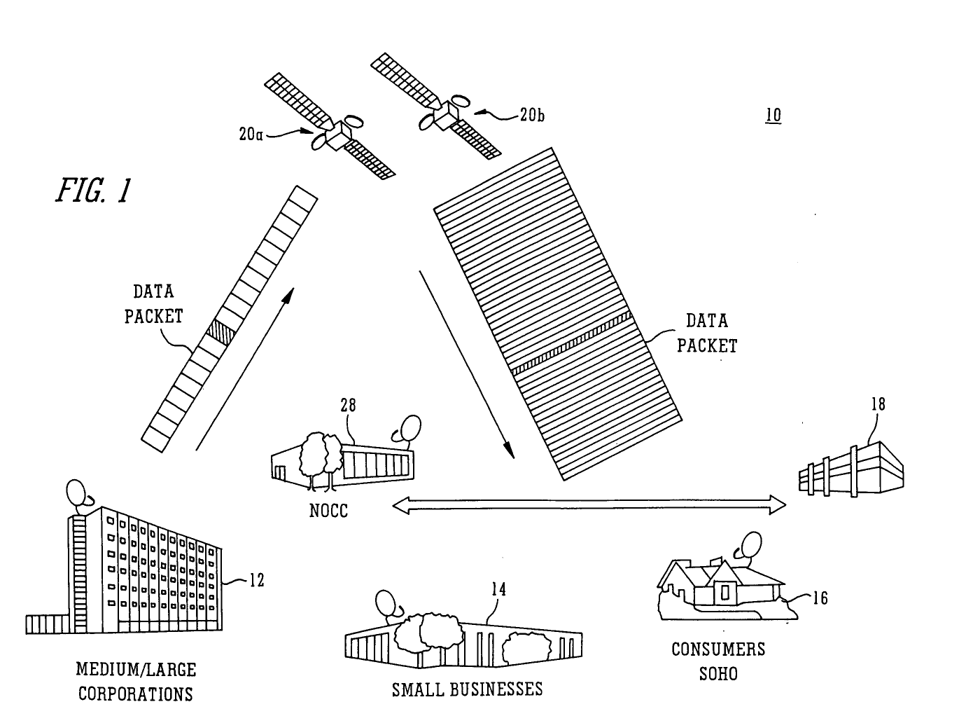

Referring to FIG. 1, the broadband multimedia satellite system 10 of the present invention preferably employs one or more geosynchronous orbit (GEO) satellites 20a and 20b and offers a wide range of user data rates and services on a bandwidth-on-demand (BOD) basis. The system uses the latest generation of high-power satellites, employing on-board digital signal processing, multiple high-gain spot beams, and on-board packet routing.

The broadband multimedia satellite system 10 is preferably capable of supporting a maximum peak capacity of at least 10 Gigabits per second (Gbps) of user data in a point-to-point (PTP) transmission mode. Delivery of services to users is provided via low-cost ultra-small-aperture terminals (USATs). The broadband multimedia satellite system 10 operates in the 30/20 GHz Ka-band spectrum allocated to Ka-band Fixed Satellite Services (FSS). The system capacity is scalable by either the addition of satellites in adjacent orbital slots, or by adding satellites in the same orbital slot that are operated in a different frequency band to enable future system expansion.

The broadband multimedia satellite system is preferably a Ka-band packet based transmission system that enables the offering of bandwidth-on-demand (BOD) connections in support of voice, data, video, and other interactive services and applications such as interactive digital communications and high-speed internet (HSI) access. The combination of small terminal size with high throughput makes the broadband multimedia satellite system useful for users ranging from large and medium-sized corporations and other organizations 12 to small businesses 14, and consumer/SOHO users 16. Raw uplink transmission data rates supported per single carrier are preferably 16.384 Mbps (8E1), 2.048 Mbps (E1), and 512 kbps (E1/4). A 128 kbps fall-back mode is also provided for improved availability of lower end terminal types. Interfaces into terrestrial networks (e.g., LAN, WAN and Internet) 18, cellular networks and corporate data networks allow seamless integration into existing communication system infrastructures.

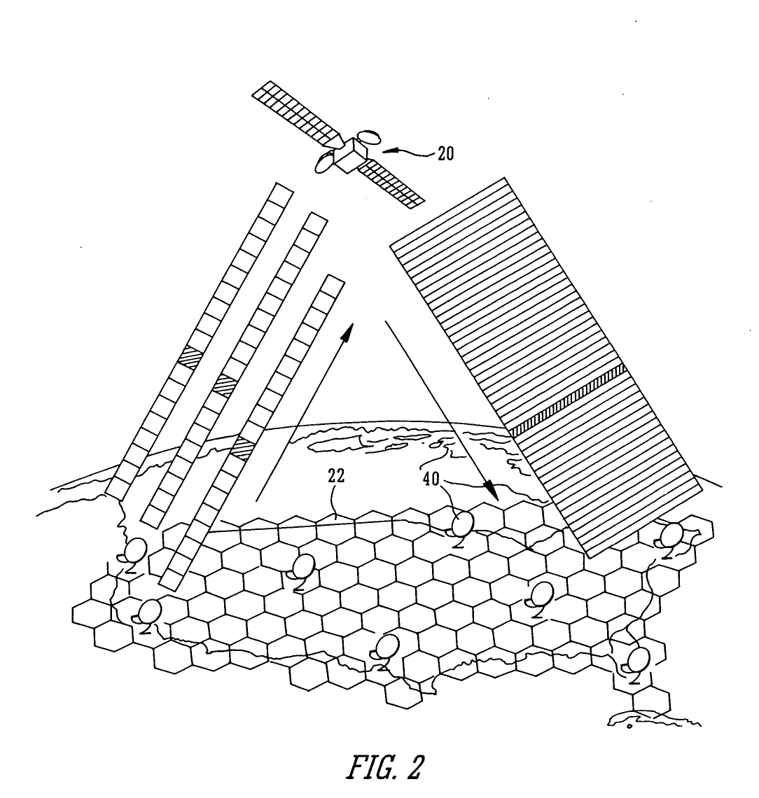

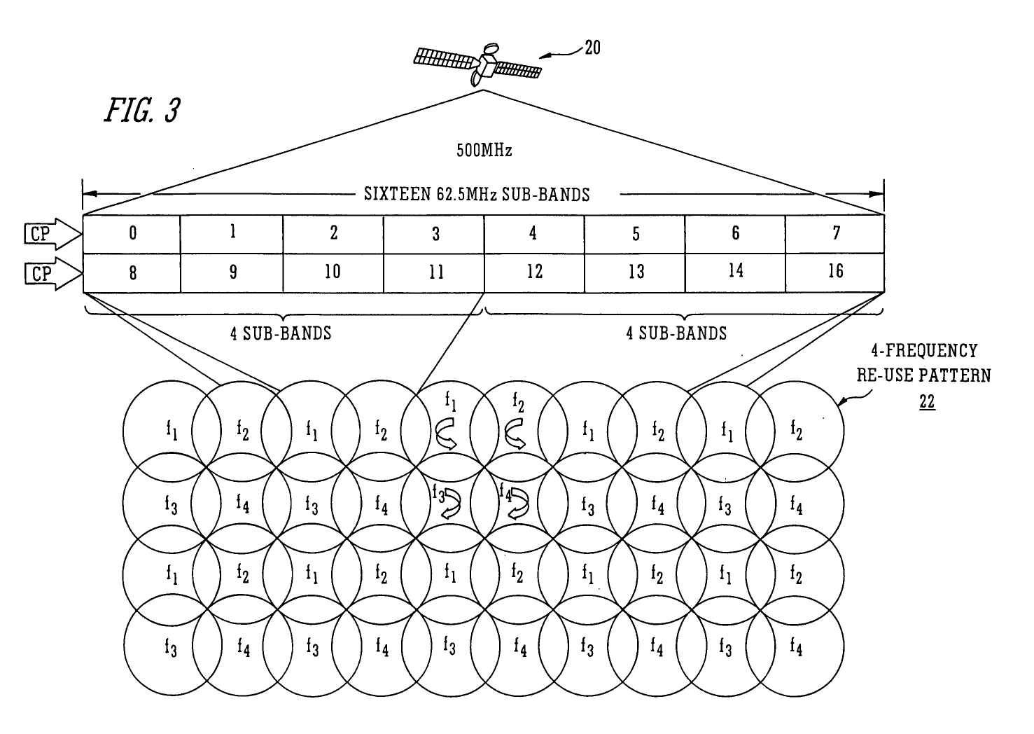

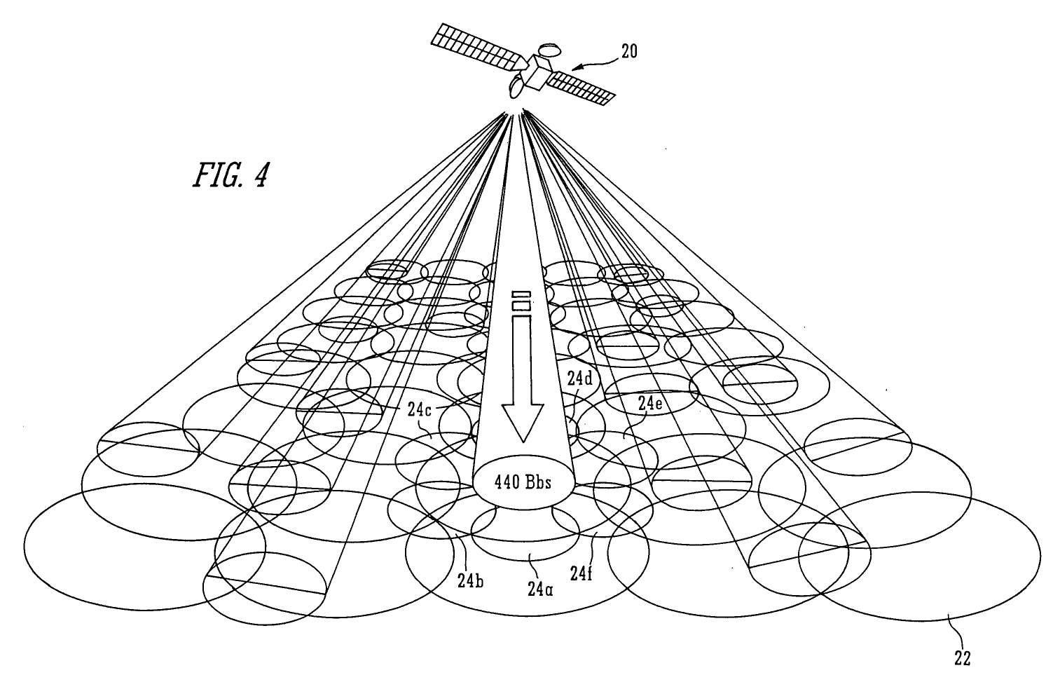

In the broadband multimedia satellite system 10 of the present invention, the uplink preferably uses 112 spot beams that provide coverage for uplink cells geographically distributed over the satellite coverage area, as illustrated in FIG. 2. The system is provided with a satellite payload which can combine inter-beam routing with a broadcast capability. Each uplink cell preferably operates on a fixed polarization with a four-cell reuse pattern to maximize capacity density, as illustrated in FIG. 3. The downlink coverage sub-divides each uplink cell 22 into seven microcells 24a through 24g, as shown in FIG. 4. Downlink microcells 24 are capable of operating in either polarization, but operationally are assigned a single polarization, except in areas where there is a high inbound capacity requirement. This enables the satellite 20 to take advantage of the peak gain available in each downlink beam for point-to-point (PTP) transmissions.

Frequency reuse is supported via both spatial and polarization reuse. As shown in FIG. 3, the broadband multimedia satellite system 10 uses circular polarization, both right hand and left hand, to simplify terminal installation and alignment with the satellite 20. Reuse provides substantial capacity increases as the broadband multimedia satellite system realizes an average of 25 times reuse on both the uplink and the downlink. Additionally, user data or broadband multimedia packets are processed, and routed by the satellite payload. The satellite 20 therefore performs a significant amount of the switching and routing responsibilities.

As shown in FIG. 1, the system 10 further includes a network operations control center (NOCC) 28, which performs a number of operations such as validating STs for authorized use of the system 10 resources and to support scheduled connections or BOD traffic. The system 10 also supports connectionless traffic that does not require NOCC involvement to establish communication.

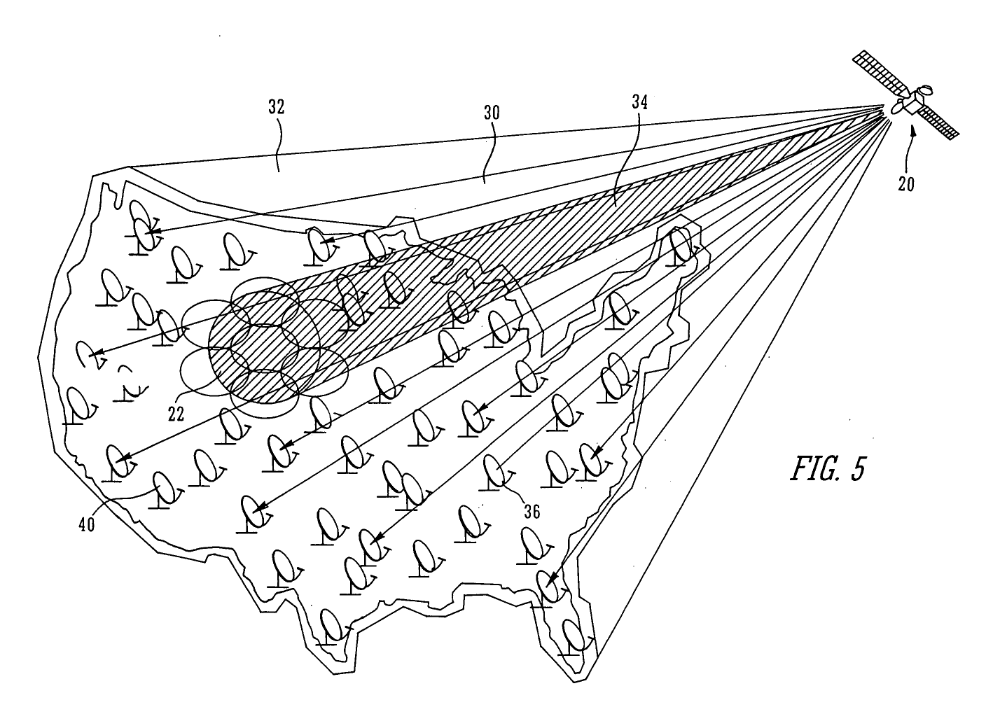

A primary transmission function of the broadband multimedia satellite 20 is not to broadcast a received broadband multimedia satellite packet to the entire coverage area. When operating in the PTP mode, the satellite payload of the present invention receives a packet from an uplink cell 22 and routes it only to the downlink cell 24 in which a destination satellite terminal (ST) is located. With reference to FIG. 5, the payload is also capable of replicating and routing a packet to up to, for example, forty multiple downlink cells 24 for point to multi-point (PMP—the aforementioned multicast mode) applications 30.

The satellite payload can also support PMP applications without replication, as indicated at 36. Each ST within a downlink microcell 24 receives all broadband multimedia packets from the payload and only processes those packets addressed to that specific ST. For a system 10 operating in North America, for example, each satellite 20 has the capability to transmit broadband multimedia packets from and to the continental United States (CONUS), Alaska, Hawaii, predefined parts of Canada and selected Latin America cities, as indicated at 32. There are preferably two CONUS broadcast beams (one for each polarization) that simultaneously cover all or a portion of the satellite coverage area. The system 10 is also configurable to transmit packets to all STs in a cell 22, that is, to cellcast, as indicated at 34.

Satellite Terminals (STs) are complete terminals with all the necessary interworking functions to interface with a given user/operator's equipment (often referred to as End-User Premises Equipment). The STs are typically used for small and medium business, branch office, SOHO, telecommuter and individual consumer applications. The End-User equipment is typically a business local area network, a workstation or an individual personal computer.

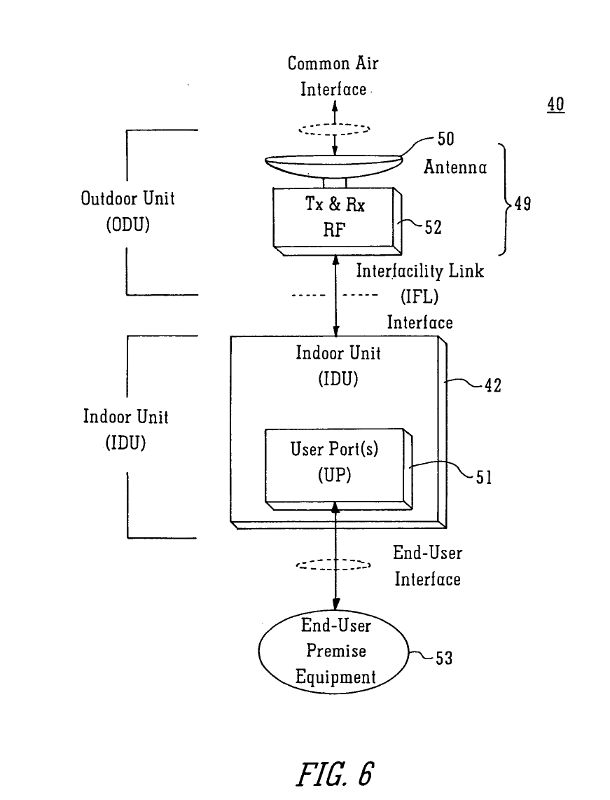

FIG. 6 illustrates an exemplary satellite terminal (ST) 40 constructed in accordance with the present invention. The ST 40 comprises an in-door unit IDU 42 having one or more User Ports 51 and an outdoor unit ODU 49 having an antenna 50 and a transmitter/receiver unit 52. The User Port 51 can comprise, for example, an Ethernet standard port 51 or the equivalent thereof. Of course, the IDU 42 can also be provided with other types of ports including asynchronous and synchronous serial data and wireless LAN, which allow the End-User equipment to be coupled to the ST.

The ST 40 can be configured as a transmit and receive device, or as a receive-only device. The receive rate is preferably 440 Mbps for the Point-to-Point transmission mode and 440/3 or 440/4 Mbps for the CONUS transmission mode. The transmission rate is selected by the user from a number of options such as 512 kilobits per second (kbps), 2 Mbps and 16 Mbps which are hereinafter referred to as 1/4E1, E1 and 8E1, respectively. The actual data throughput rates, however, can be any range of rates up to the maximum of any given transmission rate by sharing and uplink carrier between multiple STs using a time division multiple access (TDMA) scheme. For example, an ST can transmit 16 kbps of data throughput on a 1/4E1 (512 kbps) transmission rate which would allow other STs to use the remaining 496 kbps. As discussed above, the system 10 of the present invention is advantageous because it can accommodate different users, transmit rates and delivery options. The antenna 51 on the ODU 49 is preferably a relatively small antenna such as a 66 centimeter (cm) diameter antenna and varies, depending on whether or not a high transmit rate is used or whether there is high rainfall.

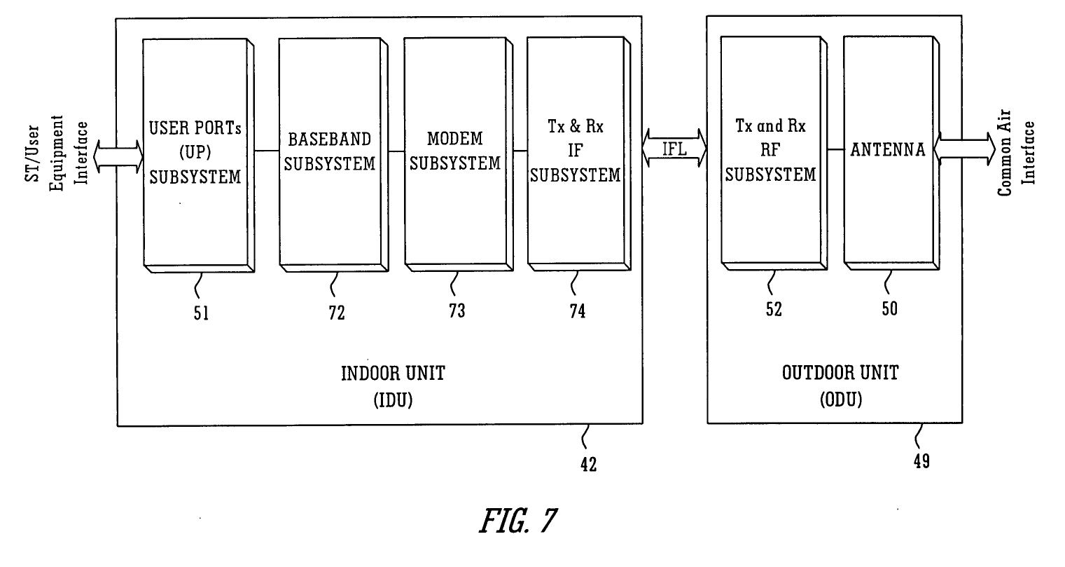

FIG. 7 is an exemplary functional block diagram of the ST 40, illustrating the main components included in a typical ST 40. Referring to FIG. 7, the IDU 42 comprises a user port subsystem 51, a baseband subsystem 72, a modem subsystem 73 and a transmitter/receiver IF subsystem 74. The ODU 49 comprises a transmitter/receiver RF subsystem 52 and the antenna 50. The operation of each of the foregoing subsystems is as follows.

First, with regard to the IDU 42. The user port subsystem 51 provides the user interface and network layer adaptation function that allows users/operators to connect their equipment to the satellite communication system. The user port subsystem 51 can be implemented as a plug in module or can built into the IDU depending on the ST model type.

The baseband subsystem 72 provides the core network and management layer functions. This subsystem also includes control and monitoring of the overall terminal including the user/operator interface.

The modem subsystem 73 provides the digital portions of the transmission layer functions including modulation, demodulation and Forward Error Correction (FEC) for the uplink and downlink communications. As explained in more detail below, this subsystem also includes the beacon synchronization and power control functions.

The transmitter/receiver IF subsystem 74 provides analog frequency conversion functions that convert the baseband modem signals to an IF signal that is suitable for the interface between the IDU and ODU via the IFL cable 79.

Turning to the ODU 49, the transmitter/receiver RF subsystem 52 provides the frequency conversion and signal conditioning functions that convert the IDU IF signals to and from an RF signal at Ka-Band. This subsystem also includes a transmit power amplifier.

Finally, the antenna subsystem 50 includes the antenna, antenna feed, OMT, and polarizer components.

FIG. 8 illustrates a block diagram of an exemplary implementation of the modem subsystem 73. Referring to FIG. 8, the modem subsystem 73 includes a demod/Beacon front end unit 81, Beacon estimator unit 82, demodulator 83, Viterbi FEC decoder 84, modulator 85, an IF/ODU control unit 86 and a bus interface control unit 87.

The modem subsystem 73, when in the receive mode of operation, functions as a multimode receiver and performs the following main functions: (1) compensating for the receive frequency offset; (2) automatic gain control (AGC) of the receive signal; (3) estimation of burst carrier phase, symbol timing, receive power; (4) adaptive equalization of downlink amplitude and phase non-linearities; (5) coherent demodulation of the downlink QPSK signals; (6) decoding and descrambling of the demodulated signal; (7) synchronizing the local frame and clock to the downlink Beacon signal; (8) supplying the reference clock derived from the Beacon to the transmitter; and (9) downlink signal to noise ratio (SNR) estimator.

In the given embodiment, the demodulator operates on QPSK signals at symbol rates of 400 Msps for PTP and either 133.333 Msps or 100 Msps for CONUS depending on system configuration. The Beacon burst is at 133.333 Msps.

The Beacon burst provides timing and frequency references for the demodulator and the other components of the ST. The Beacon burst consists of a unique word which allows the Beacon burst to be discriminated from the CONUS bursts, and a PN sequence whose period is 256 frames. The process for synchronization to the Beacon burst comprises: (1) estimating the downlink frequency offset by performing fast Fourier transforms on the Beacon burst, and correcting the frequency offset by tuning the front-end NCO; (2) estimating the external AGC setting, the CONUS and PTP AGC are set relative to the Beacon burst's signal strength; and (3) acquiring synchronization with the Beacon PN sequence which involves closed loop control of a local VCXO via a Delay Locked Loop (DLL).

Once the Beacon has been acquired, frame timing and clock synchronization is established. At this point, demodulation of the data bursts can begin. In order for this to happen, the demodulator must know the number of CONUS and PTP bursts in the downlink frame. Initially, the demodulator does not have this information, so initially an assumption is made that all bursts following the Beacon are PTP bursts and that they have the same polarization as the Beacon. As the demodulator demodulates each PTP downlink burst, the ST Baseband Subsystem searches the demodulated Transmission Information Packets (TIP) for the current Time Of Day (TOD) and the time plan for the current frame. This information, which is controlled and generated by the NOCC and transmitted to the ST, indicates which portion of the given frame is allocated to PTP data and which portion is allocated to CONUS data. At this point, the Processor loads the current TOD and time plan into the Demodulator, which it then uses to demodulate both PTP and CONUS. In other words, because the NOCC informs the demodulation which portion of the frame is allocated to PTP data and CONUS data, the ST knows where in the frame the transition between PTP data and CONUS data occurs, and processes the data accordingly. The system has the ability to change the time plan (i.e., the portion of the frame allocated to PTP and CONUS) on a frame-by-frame basis to enable tailoring the delivery capability to the actual traffic and service requirements.

The demodulation process consists of the following operations, which were described in detail in the parent application to which the present application claims priority.

First, the data output from the IF subsystem 74 is input to the demodulator and processed to remove DC offsets, I/Q amplitude and phase imbalances using an adaptive compensation circuit contained in the Demod/Beacon Front End 81. The majority of any frequency offset is removed by a Complex Mixer/NCO whose frequency is controlled by the Beacon frequency estimate. The signal is matched filtered and decimated by a multi-rate Complex Filter block. A Unique Word Correlator block correlates the signal with the known unique word pattern. The output of the correlator is used for burst detection and parameter estimation.

Detection of the unique word provides a timing reference for synchronizing and enabling the demodulator 83 and decoder blocks 84. Estimation of the power of the Beacon burst is used for control of the external AGC loop located in the IF Subsystem 74. Estimation of the burst level is fed to the Burst AGC block to correct the level of the burst. Estimation of the carrier phase of the burst is fed to the NCO to allow coherent demodulation of PTP and CONUS bursts. Estimation of the symbol phase of the burst is fed to the Timing Interpolating filter to adjust the symbol phase of the burst to the optimum sampling point. The decimated, phase adjusted signal is sliced by the Soft Decision block. Soft decision data is fed to the Viterbi decoders for error correction.

Next, decoded data from the Viterbi decoder 84 is deinterleaved. Deinterleaved data is fed to Reed-Solomon decoders for further error correction. Decoded data from the Reed-Soloman decoders is descrambled. Descrambled data along with the demodulator status words are output to the Baseband Processor.

As noted above, the system 10 supports Point-to-Point (PTP) and CONUS broadcast packet transmission to the STs 40 within a single downlink frame. Moreover, each downlink frame can be dynamically partitioned to adjust the capacity split between PTP and CONUS broadcast traffic. For example, the NOCC can change the partitioning at any time as often as necessary by broadcasting a system message to all ST's that defines the partitioning. The message is not synchronized to the downlink frame. An ST receives the message from the NOCC and on the next frame boundary it switches in accordance with the partitioning specified in the system message. Depending on the limits of the system (i.e., the frequency of the NOCC's system messaging) the system could change the partitioning on a frame-by-frame basis, or less frequently (i.e., at different times of day to accommodate changing traffic patterns).

In the given embodiment, PTP transmission is supported via 24 independent high rate (400 Msps) hopping beams (i.e., carrier), with 12 such beams in each polarization. Each carrier contains the user traffic for a given geographic area, and each of the 24 carriers can be redirected every downlink slot time (21.73 μs) to service a different downlink micro-cell. The downlink supports CONUS broadcast traffic with one of two carriers (one per polarization) serving a CONUS broadcast shaped beam operating at 133.33 Msps or 100 Msps.

The system also supports two subclasses of PTP transmissions, referred to as cell cast and multicast. Multicast is the process of replicating the packet and transmitting it to multiple locations (up to 40 downlink beams) via the normal PTP transmission process. Multicast traffic consists of packets originating from a source node and being distributed to a selected group of destination nodes. The multicast packets are replicated before they proceed to the routing stage. Once replicated the multicast packet is treated in the same manner as the PTP or CONUS packet that has a unique destination address.

In contrast, cell cast is used to transmit system information messages from the satellite 20 and NOCC 28 to STs 40. In the given embodiment, when performing a cell cast transmission, the satellite directs a downlink beam (0.18° PTP spot) to the center of an uplink cell with 4.5 dB additional EIRP to allow reception by all micro-cells within the uplink cell.

In the given embodiment, the downlink frequency band consists of the contiguous spectrum of 500 MHz contained within the downlink Ka Band allocated to Fixed Satellite Services (FSS). The Frequency Band selected for the North America deployment of the system 10 is preferably 19.7-20.2 GHz. The bandwidth for the PTP mode is 500 MHz, while for the CONUS broadcast mode is 250 MHz, with a center frequency of 19.95 GHz. The frequency deviation from normal is maintained within a factor of 10-7.

In the given embodiment, the downlink uses a transmit phased array antenna to create the spot beams or shaped beam coverages. The high gain spot beams and shaped broadcast beams are generated via phase optimization. A single aperture has the ability to radiate multiple simultaneous PTP beams that share an SSPA power pool among beams in each polarization. The broadcast coverage can be dynamically changed from a regional beam to a CONUS coverage beam in each polarization. Also, each broadcast beam can utilize the entire power pool available for each polarization.

The downlink also supports a beacon mode that is used for system synchronization. Specifically, the beacon provides the frequency and time references to allow an ST 40 to synchronize to the satellite 10. The timing beacon is implemented as a burst in the first slot (Beacon Slot) of each downlink 3 msec frame as described in the “Downlink Waveform” section below.

Both polarizations are transmitted at the same nominal time and power value during the Beacon Slot. Each polarization has its own Unique Word (UW) and Packet Numbering (PN) sequence. The slot UW and partial PN sequence allows the beginning of the 1.536 second super-frame to be identified. The PN sequence stops at the end of each slot and resumes at the next Beacon Slot. The satellite downlink frame and uplink frame are aligned with the beacon.

In the given embodiment, downlink beams are transmitted in one of two polarization's (LHCP or RHCP). Downlink micro-cells are nominally assigned to the polarization opposite the associated uplink cell. The system 10 also has the capability to use dual polarizations in a limited number of downlink micro-cells to meet high local capacity peaking needs.

In the given embodiment, the downlink PTP carrier utilizes QPSK modulation using symbol pulse shaping that approximates a square root raised cosine power spectral density with a roll-off factor (β) of 0.25. With a 400 Msps burst rate, β=0.25 ensures signal spectrum is contained within the allocated 500 MHz bandwidth. The ⅓ and ½ rate downlink CONUS carrier uses NRZ QPSK (unshaped). Pulse shaping for CONUS is not needed since the spectrum is contained within the System allocation, and elimination of the pulse shaping reduces the waveform sensitivity to High Power Amplifier (HPA) impairments. The downlink also implements concatenated error correction codes with interleaving for forward error correction (FEC).

An ST 40 has the capability to receive the CONUS broadcast on either polarization. In the given embodiment, the polarization switching will occur during the last 7 usec of the beacon and idle slots, and the ⅓ and ½ rate CONUS broadcast duration may be adjusted in 3 slot increments.

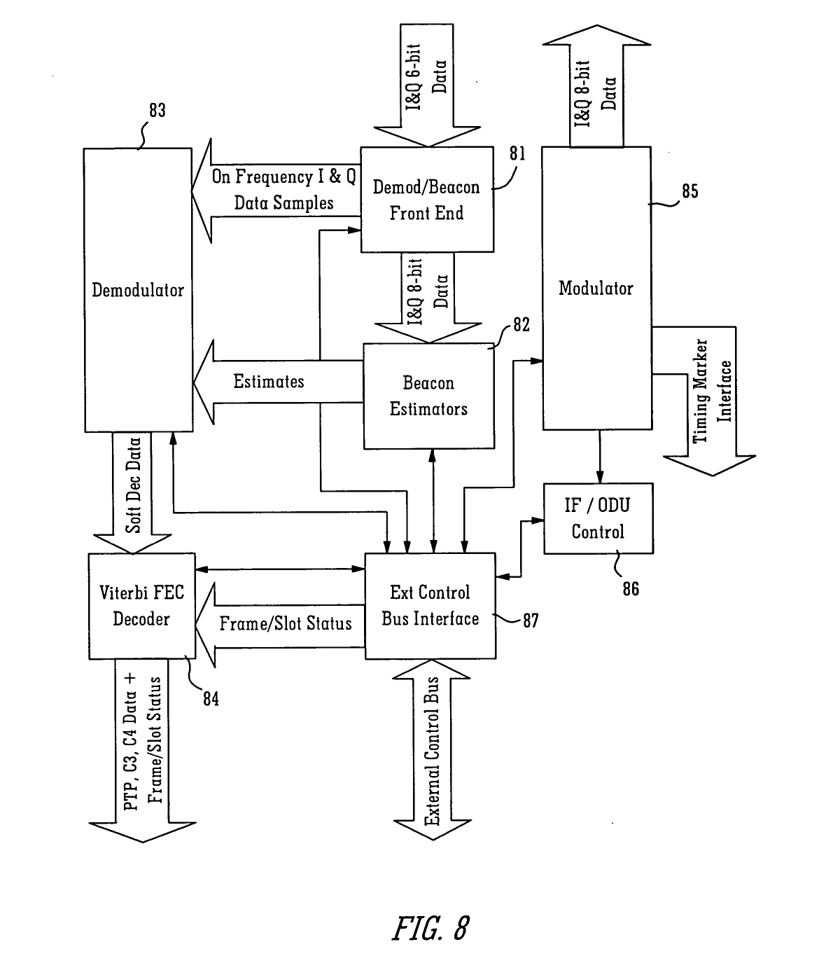

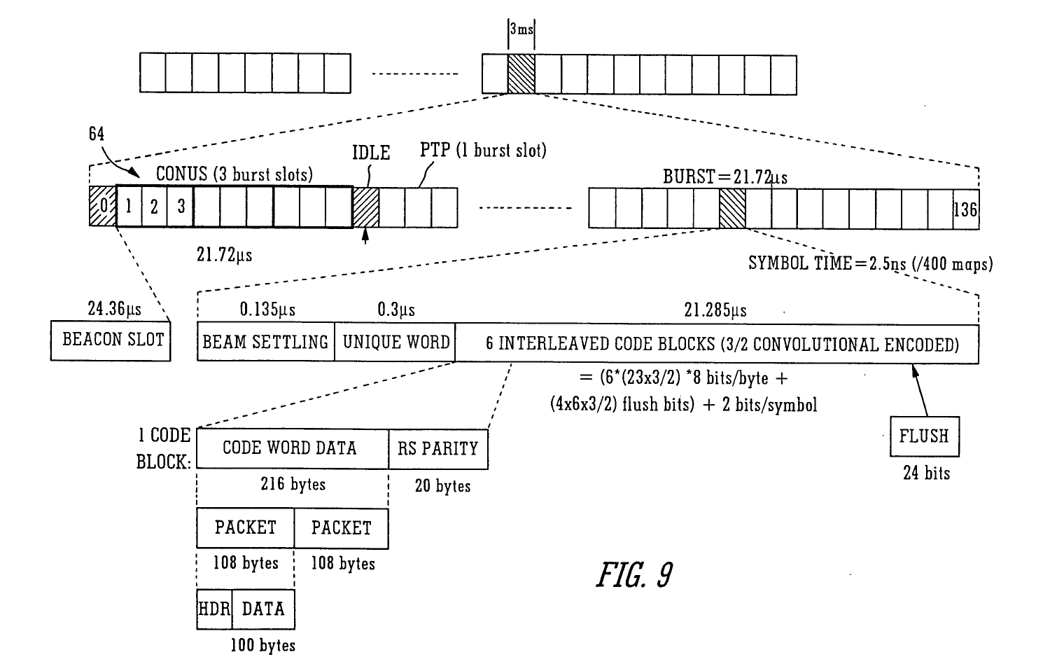

As shown in FIG. 9, in the given embodiment, a downlink frame 64 having a duration of 3 msec is divided into 138 slots that consists of a beacon burst slot of 24.36 μs duration, CONUS broadcast burst slots, an idle slot and PTP burst slots of 21.72 μs duration each. As discussed above, the beacon slot transmits a portion of the 1.536 second PN sequence for synchronization.

The idle slot enables an ST 40 to perform noise measurements. During this time, the payload spreads its RF power using a defocused beam. It also provides an opportunity for an ST 40 to switch back its polarization if the CONUS broadcast is different than PTP. As shown in the example of FIG. 9, once the CONUS transmission is completed, and subsequent to the idle slot, the PTP transmission is performed contiguously until slot 136 (138th slot) is reached.

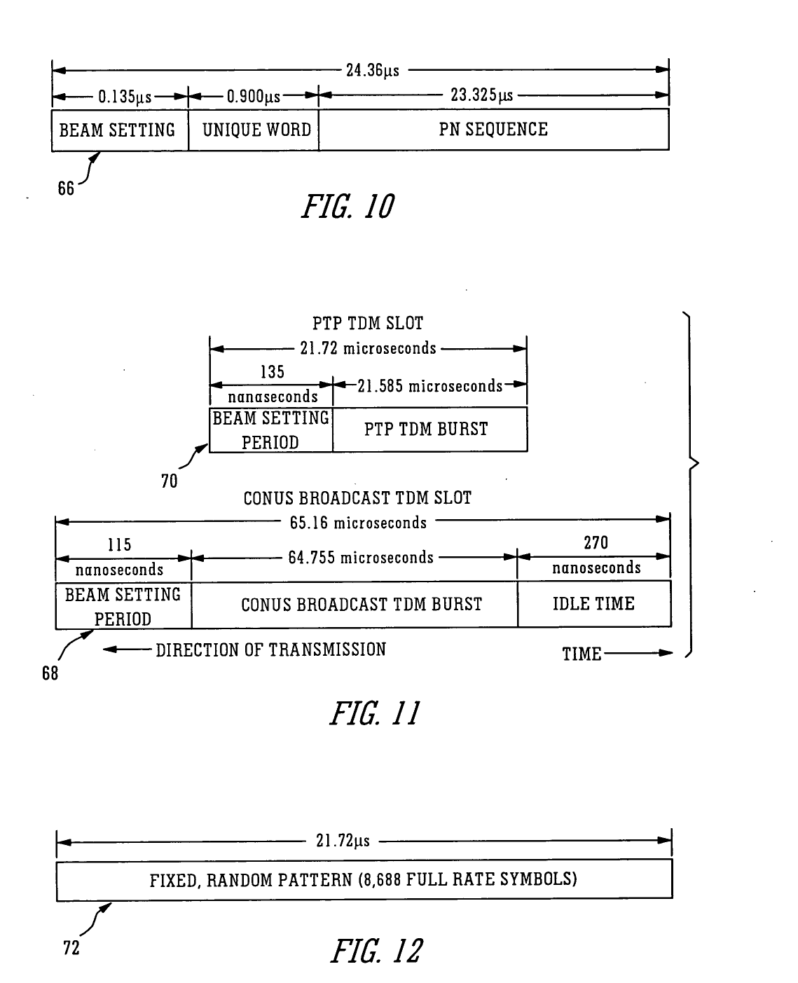

As shown in FIG. 10, a beacon burst 66 consists of a beam settling period, an UW and a PN sequence in this example. Transmission during the beacon slot is at the rate ⅓ mode. To minimize cross-pol interference, multiple unique words are utilized by the system downlink. Every ST 40 receiving on the same polarization in an uplink cell is assigned the same downlink unique word. A different downlink unique word 7-cell pattern is used for the opposite polarization for a total of 14 downlink unique words. Since CONUS and beacon bursts are TDM multiplexed and since the burst rate is different from the PTP bursts, the unique words are reused. 2 of the 14 unique words (already defined for PTP) are used for CONUS broadcast transmission (one UW per polarization) and an additional 2 of the 14 unique words are used for beacon transmission.

As illustrated in FIG. 11, each downlink data burst 68 for the CONUS broadcast and each PTP slot 70 is composed of a downlink beam switching/settling time, followed by a unique word, followed by six interleaved code blocks. Transmissions during the PTP time slots are in the PTP full rate mode, while transmissions during the CONUS broadcast time slots are in the rate ⅓ mode.

The beam settling time is used to account for phase shifter transients in the payload phased array elements in between hops. The length of the unique word is selected so the probability of not detecting the burst correctly is negligible, when compared to the desired PLR. As shown in FIG. 12, the idle slot 72 consists of a fixed, random pattern. Also, transmission during the idle slot is at the full rate mode.

A unique word (UW) is transmitted at the start of the burst after the beam-settling period. To minimize cross-pol interference, multiple unique words are employed by the system downlink. Every terminal receiving on the same polarization in an uplink cell is assigned the same downlink unique word. A group of 7 uplink cells form a 7-cell downlink unique word re-use pattern, and the re-use pattern is repeated to cover the system NA coverage area. A different downlink unique word 7-cell re-use pattern is used for the opposite polarization for a total of 14 downlink unique words. Since the CONUS and Beacon bursts are multiplexed, and since the burst rate is different from the PTP bursts, the downlink unique words are be re-used.

Importantly, as noted above, the amount of time allocated to PTP bursts and CONUS bursts within a given frame is dynamically variable on a frame to frame basis. This flexibility allows the system to efficiently transmit multiple types of services to the various STs in a substantially concurrent manner. Moreover, as the PTP bursts and CONUS bursts are time multiplexed within the given frame and transmitted over the same carrier signal, a single receiver can be utilized to receive both modes of services. Thus, the system provides the operator the ability to easily control the content being delivered to multiple STs on a frame by frame basis, and effectively deliver multiple services to a given ST in a concurrent manner, without any substantial increase in the cost of the individual ST.

For example, during a national broadcast which is transmitted to the entire US utilizing the CONUS mode, it may be desirable to provide localized commercials specific to certain geographic regions. Utilizing the system of the present invention, such localized commercials can be transmitted to the specific geographic regions utilizing the PTP mode of operation, while the national aspect of the broadcast is transmitted utilizing the CONUS mode. In addition, the sources for the broadcast transmissions can be from geographically diverse locations (i.e. not require to back-haul to central uplink facility, thus a savings on terrestrial network costs). Moreover, the percent of each frame allocated to the PTP mode and the CONUS mode can be varied on a frame-to-frame basis, so as to maximize the available data rate for each service as appropriate.

As a result of the capabilities of the multi-mode receiver of the present invention, as an example, an operator/user could be performing all of the following functions in a concurrent manner using a single multi-mode receiver:
web browsing—internet access through an ISP;
participating in a peer-to-peer application like file sharing (e.g., Napster), video conferencing or other collaboration application using the mesh capability;
telecommuting where the user/operator can access a corporate network which could be one or more locations;
broadcast service such as content distribution and streaming multi-media (e.g., latest Victoria Secrets catalog);
local broadcast; and
national broadcast

The present invention provides important advantages over prior art systems. Most importantly, as the amount of time allocated to PTP bursts and CONUS bursts within a given frame is dynamically variable on a frame to frame basis, the present system can efficiently transmit multiple types of services to the various STs in a substantially concurrent manner. Moreover, as the PTP bursts and CONUS bursts are time multiplexed within the given frame and transmitted over the same carrier signal, a single receiver can be utilized to receive both modes of services. Thus, the system provides the operator the ability to easily control the content being delivered to multiple STs on a frame by frame basis, and effectively deliver multiple services to a given ST in a concurrent manner, without any substantial increase in the cost of the individual ST.

One of the most important advantages of the present invention is that it allows multiple multimedia broadband services to be delivered multiple ways (e.g., PTP, CONUS, Cellcast, multicast, etc.) from multiple locations (full mesh, multi-star and star network topologies) in a concurrent manner using a single cost effective receiver.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A satellite-based communications network employing at least one satellite and a plurality of user terminals adapted for use with said communications network, said network comprising:
a transmitter for transmitting data to said plurality of user terminals, said data comprising a plurality of broadcast modes, said transmitter transmitting said data in a packetized format in which a predetermined number of data packets are transmitted in a frame, said frame being defined as a predetermined period of time, said transmitter transmitting each of said plurality of broadcast modes utilizing a single carrier frequency;
wherein each of said plurality of user terminals includes a single receiver for receiving said transmitted data and for regenerating said data so that said data is made available to a device coupled to said user terminal.

2. The satellite-based communications network of claim 1, wherein said plurality of broadcast modes include a localized broadcast in which said data is transmitted to only a subset of said plurality of user terminals, and a non-localized broadcast in which the data is transmitted to all of said plurality of user terminals.

3. A satellite-based communications network of claim 1, wherein at least two different broadcast modes are transmitted within a given frame utilizing the same carrier frequency.

4. A satellite-based communications network of claim 3, wherein the portion of said given frame allocated to each of said two different broadcast modes is dynamically adjustable.

5. A satellite-based communications network of claim 4, wherein said at least two different broadcast modes include a point-to-point mode, and a CONUS mode, said point-to-point mode utilized for transmitting said data to select ones of said plurality of user terminals, said CONUS mode utilized for transmitting data to all of said user terminals.

6. A satellite-based communication network of claim 1, wherein said transmitter is capable of transmitting data originating from multiple sources, which are located at geographically distinct locations, within a single frame utilizing said single carrier frequency.

7. A satellite-based communication network of claim 1, wherein said transmitter is resident in said satellite.

8. A method for transmitting data within a satellite-based communications network including at least one satellite and a plurality of user terminals, said method comprising the steps of:
transmitting data to said plurality of user terminals, said data comprising a plurality of broadcast modes, said data being transmitted in a packetized format in which a predetermined number of data packets are transmitted in a frame, said frame being defined as a predetermined period of time, said plurality of broadcast modes be transmitted utilizing a single carrier frequency;
receiving said transmitted data; and
regenerating said data so that said data is made available to a device coupled to said user terminal.

9. The method for transmitting data within a satellite-based communications network of claim 8, wherein said plurality of broadcast modes include a localized broadcast in which the data is transmitted to only a subset of said plurality of user terminals, and a non-localized broadcast in which the data is transmitted to all of said plurality of user terminals.

10. The method for transmitting data within a satellite-based communications network of claim 8, wherein at least two different broadcast modes are transmitted within a given frame.

11. The method for transmitting data within a satellite-based communications network of claim 10, wherein the portion of said given frame allocated to each of said two different broadcast modes is dynamically adjustable.

12. The method for transmitting data within a satellite-based communications network of claim 11, wherein said at least two different broadcast modes include a point-to-point mode, and a CONUS mode, said point-to-point mode utilized for transmitting said data to select ones of said plurality of user terminals, said CONUS mode utilized for transmitting data to all of said user terminals.

13. The method for transmitting data within a satellite-based communications network of claim 8, wherein said transmitted data contained within a single frame originates from multiple sources, which are located at geographically distinct locations.

14. A receiver for use in a satellite-based communications network employing at least one satellite and a transmitter for transmitting data to said receiver, said data comprising a plurality of broadcast modes, said transmitter transmitting said data in a packetized format in which a predetermined number of data packets are transmitted in a frame, said frame being defined as a predetermined period of time, said transmitter transmitting each of said plurality of broadcast modes utilizing a single carrier frequency;
said receiver comprising a single receiver for receiving said transmitted data and for regenerating said data so that said data is made available to a user terminal coupled to said receiver,
wherein said receiver determines the portion of a given frame allocated to a given one of said plurality of broadcast modes on the basis of information provided by said transmitter.

15. The receiver for use in a satellite-based communications network of claim 14, wherein said plurality of broadcast modes include a localized broadcast and a non-localized broadcast.

16. The receiver for use in a satellite-based communications network of claim 14, wherein at least two different broadcast modes are transmitted within a given frame utilizing the same carrier frequency.

17. The receiver for use in a satellite-based communications network of claim 16, wherein the portion of said given frame allocated to each of said two different broadcast modes is dynamically adjustable.

18. The receiver for use in a satellite-based communications network of claim 14, wherein said at least two different broadcast modes include a point-to-point mode, and a CONUS mode.

19. The receiver for use in a satellite-based communications network of claim 14, wherein said transmitter is capable of transmitting data originating from multiple sources, which are located at geographically distinct locations, within a single frame utilizing said single carrier frequency.
